(19) United States
(12) Patent Application Publication
(10) Pub. No.: US 2006/0027662 A1
(43) Pub. Date: Feb. 9, 2006

(54) Color-coding system

(76) Inventor: Adnan Subhi Baradi, Amman (JO)

Correspondence Address: ABELMAN, FRAYNE & SCHWAB, 666 THIRD AVENUE, 10TH FLOOR, NEW YORK, NY, 10017, US

(21) Appl. No.: 11/069,808

(22) Filed: Feb. 28, 2005

Related U.S. Application Data
(60) Provisional application No. 60/547,960, filed on Feb. 27, 2004.

(51) Int. Cl. G06K 7/12

(52) U.S. Cl. 235/469; 235/462.04

(57) ABSTRACT

A color coding system and method process the data of an image or document to blend the data using a predetermined mapping to generate color indicia being a series of color bars or shapes having different lengths and heights. The color indicia is uniquely associated with the input data, and the use of color has a greater ability to visually distinguish one object from another.

### CROSS-REFERENCE TO RELATED APPLICATIONS

This application is related to U.S. provisional application No. 60/547,960, filed on Feb. 27, 2004, now abandoned, the disclosure of which is incorporated herein by reference.

### BACKGROUND OF THE INVENTION

1. Field of the Invention

This invention relates to identification information, and in particular to the use of indicia with color coding for enhanced identification of data and objects.

2. Description of the Related Art

Known computer and data systems for document storage and visualization, such as the World Wide Web and the Internet, use data employing markup languages such as Hypertext Markup Language (HTML) formatting, as well as data formatting in Extensible Markup Language (XML) and Standard Generalized Markup Language (SGML). Such data formatting uses color code definitions for specifying codes corresponding to specific colors, such as the major colors RED, GREEN, and BLUE in the RED-GREEN-BLUE (RGB) color scheme.

General codes are used by markup language to specify the assignment of the contents of a web page related to the size and type of fonts and colors throughout the web page. However, in the prior art, such use of color is typically ornamental, or may be indicative only of a function, such as black for unactivated or unaccessed hyperlinks or red for activated or accessed hyperlinks.

Colors may also be used to encode data, for example, in black-and-while bar codes such as two-dimensional or zebra barcodes encoding product information in Universal Product Code (UPC) symbols on product packaging, or in three-dimensional data codes. Such use of colors is limited to dealing with identification and verification purposes.

Heretofore, such use of colors to encode data has been silent or passive; that is, different colors merely indicate the appearance of one region to be different from the appearance of another region. Any functional aspects of the colors serve only to provide contrasts to indicate YES/NO or ONE/ZERO.

Accordingly, for a bar code with, for example, twenty vertical black lines against a white background, only 2²⁰ objects=1,048,576 objects may be uniquely identified. For large inventories, such as in warehouses, such bar codes may be insufficient, and may require a lengthy bar code extending over a significant portion of the object being labeled and uniquely identified for tracking.

For identifying people, such as with Social Security numbers in the United States, black-and-white bar codes may be used, but would require over twenty-eight vertical lines, while larger populations in the European Union, India, China, or the entire world would require even lengthier bar codes with many more vertical lines. In addition to identifying millions or even billions of people, the identification and tracking of billions of objects globally becomes unwieldy with black-and-white bar codes.

When such black-and-white vertical lines in bar codes are positioned more densely to minimized their size on a product with more lines used to identify more objects, people as well as automated scanning machines may be unable to distinguish one black-and-white bar code from another having similar but distinct appearances.

However, people as well as automated scanning machines are able to easily distinguish two or more contrasting colors. For example, the colors of the basic spectrum ranging from red to violet are readily identifiable.

In addition, such bar codes typically have fixed heights and orientations in a linear arrangement. However, people as well as automated scanning machines are able to readily distinguish different arrangements of colors in many different orientations beyond a fixed linear arrangement. For example, pie charts with at least two colors for the pie segments as well as bar charts used, for example, in business presentations are easily understandable to show distinct information using color.

A need exists for the active use of colors and color coding of data to enhance the identification of data and objects.

### BRIEF SUMMARY OF THE INVENTION

A color coding system and method process the data of an image or document to blend the data using a predetermined mapping to generate color indicia being a series of color bars or shapes having different lengths and heights. The color indicia is uniquely associated with the input data, and the use of color has a greater ability to visually distinguish one object from another.

### BRIEF DESCRIPTION OF THE SEVERAL VIEWS OF THE DRAWINGS

Preferred embodiments of the invention are disclosed hereinbelow with reference to the drawings, wherein:

FIG. 1 is a schematic block diagram of the color coding system of the present invention;

FIG. 2 is a flowchart of operation of the present invention;

FIG. 3 is an example webpage for inputting the identifying information to generate color indicia;

FIG. 4 is an example of a color bar code as the color indicia;

FIG. 5 is an example of a colored shape as the color indicia;

FIG. 6 is an example of a mapping;

FIG. 7 is an example birth certificate with a color bar code; and

FIG. 8 is an example travel bag with a tag having a color bar code.

### DETAILED DESCRIPTION OF THE INVENTION

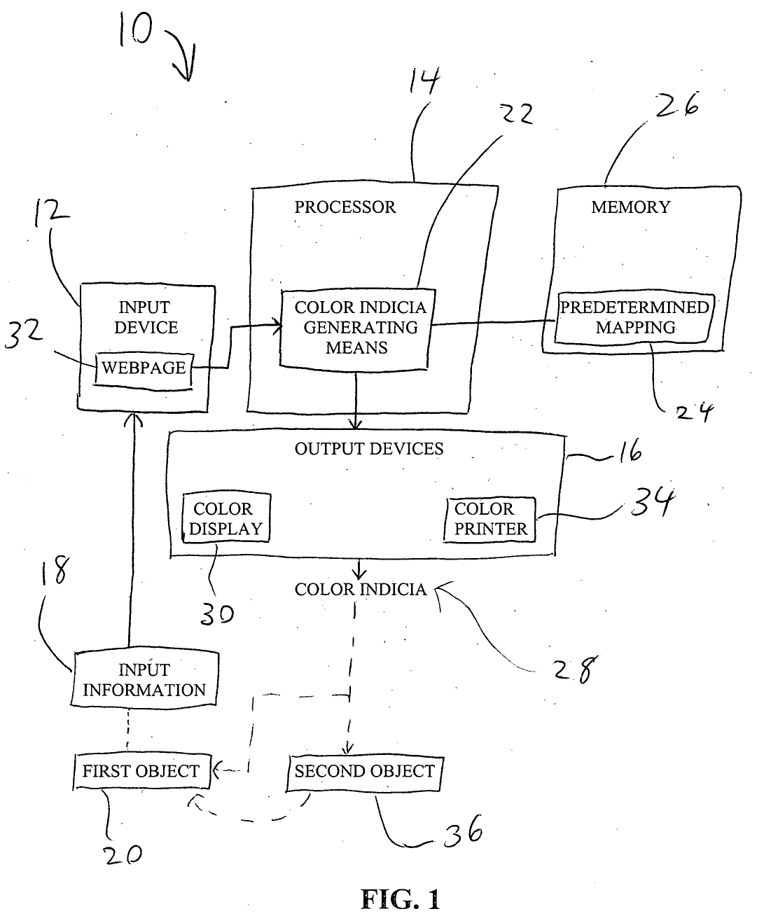

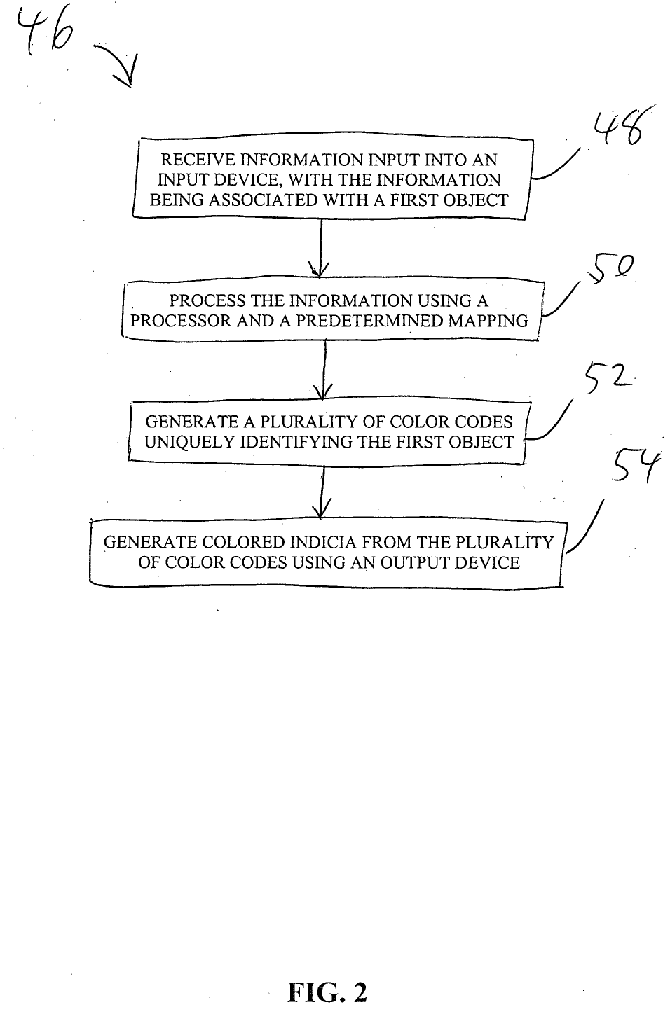

As shown in FIGS. 1-2, a color coding system 10 is a computer-based apparatus, which may be a distributed computer system, including an input device 12, a processor 14, and at least one output device 16. The input device 12 is used for inputting information 18 associated with a first object 20. The processor 14 processes the information 18 using software implementing color indicia generating means 22 and a predetermined mapping 24 stored in a memory 26 to generate a plurality of color codes uniquely identifying the first object 20. The output device 16 generates color indicia 28 from the plurality of color codes, with the color indicia 28 encoding the information 18 associated with the first object 20, with the color indicia 28 being viewable on a physical substrate, and with the color indicia 28 including a plurality of different colors selected from a predetermined palette lacking the color black.

In an example implementation, the color-coding system 10 may be an Internet-accessible computer including a “PENTIUM” microprocessor commercially available from “INTEL CORPORATION”, including 1 MB of RAM as the memory, 1 GB of hard drive storage, and executing the “WINDOWS” operating system commercially available from “MICROSOFT CORPORATION”. Accordingly, the input device 12 includes a mouse and optionally a keyboard for inputting the information 18 through a graphic user interface (GUI).

The at least one output device 16 includes at least a color display 30 capable of displaying at least the predetermined palette of colors. As defined and used herein, the term “color” is not limited to black and white, but may be any known color or combinations thereof.

The processor 14 may include the microprocessor of a personal computer of the user inputting the input information 18 to generate the color indicia 28. The processor 14 may also include and/or be operatively connected to a web server; for example, a server computer commercially available from “IBM CORPORATION” capable of running the “WINDOWS 2003 SERVER” software available from “MICROSOFT CORPORATION”. Alternatively, the personal computer of the user may be a client computer operating as the input device 12 connected to a web server acting as the processor 14 of the color-coding system 10.

The predetermined palette may include, for example, the colors of the spectrum selected from the group of: red, orange, yellow, green, blue, indigo, violet, and combinations thereof. With just the seven basic colors of the spectrum being red, orange, yellow, green, blue, indigo, violet, a color indicia forming a color bar code shown, for example, in FIG. 4, having ten bars, the number of unique color bar codes equals 7¹⁰=282,475,249 distinct color bar codes capable of uniquely representing at least every person in the United States according to the Year 2000 Census.

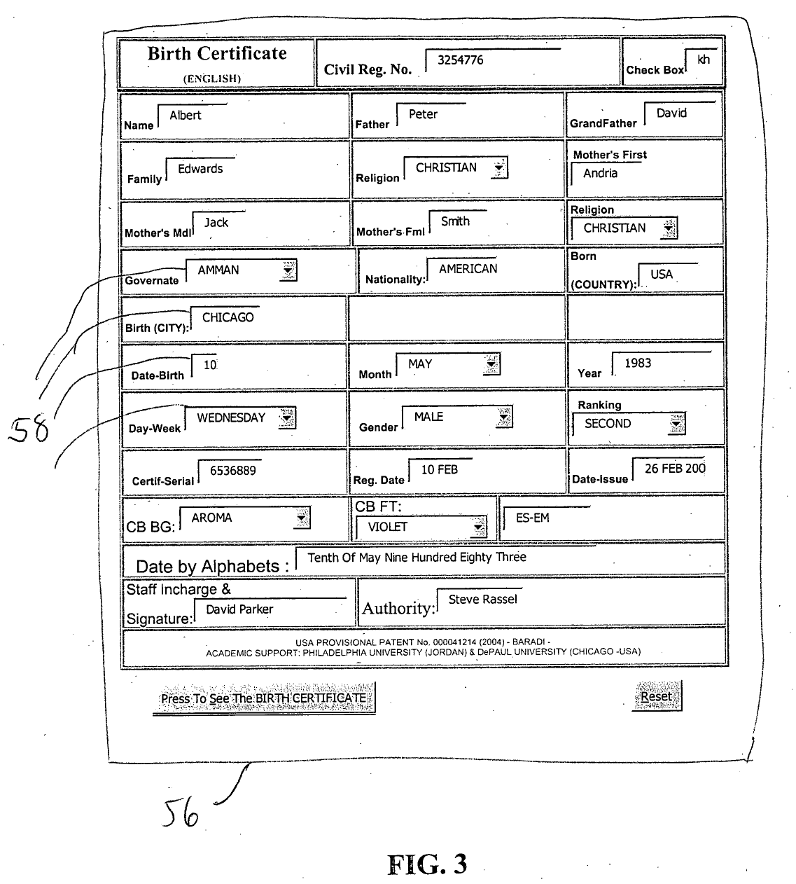

In a preferred embodiment, the input device 12 is and/or includes a webpage 32, for example, as shown in FIG. 3, which is displayed on the browser of a personal computer of a user for receiving the information 18 from the user including a plurality of user-inputted menu selections. The processor 14 is a web server operatively connected to the input device 12 through a network such as the Internet.

In one example embodiment, the output device 16 is and/or includes a multi-color display 30, and the physical substrate is a screen of the multi-color display 30. In another example embodiment, the output device 16 is and/or includes a color printer 34, and the physical substrate is the first object 20 itself, or alternatively the physical substrate is a second object 36 attachable to the first object 20 to be associated therewith. For example, the first object 20 may be a travel bag or other known types of items of luggage, and the second object 36 may be an identification (ID) tag removably secured to the travel bag. Alternatively, the second object 36 may be an adhesive sticker to be disposed on the first object 20, such as a color-coded seal for a birth certificate as the first object 20.

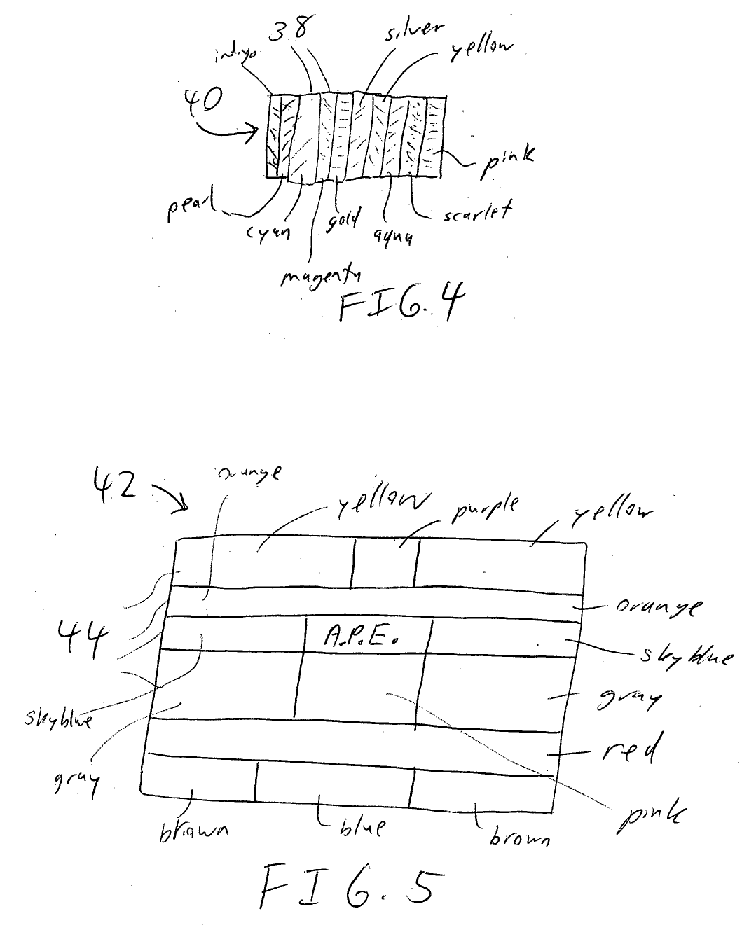

The color indicia 28 may have any predetermined shape. For example, in a first embodiment, the color indicia 28 are arranged in a series 38 of parallel color lines representing a color bar code 40, as shown in FIG. 4. Alternatively, the color indicia 28 is a colored shape 42 having a set 44 of smaller shapes are arranged in a rectangular array having at least two colored shapes in vertical direction, and at least two colored shapes in a horizontal direction, as shown in FIG. 5. The colored shape 42 may be rectangular, and the smaller shapes 44 may be smaller rectangles of varying sizes.

In operation, the system 10 operates using the method 46 shown in FIG. 2, with the method for color coding the first object 20 including the steps of: receiving information 18 in step 48 input into the input device 12, such as the example webpage 56 in FIG. 3, with the information 18 being associated with the first object 20; processing the information 18 in step 50 using the processor 14 and the predetermined mapping 24 with the color indicia generating means 22; generating a plurality of color codes in step 52 uniquely identifying the first object 20; and generating the color indicia 28 in step 54 from the plurality of color codes using the output device 16, with the color indicia 28 encoding the information 18 associated with the first object 20, with the color indicia 28 being viewable on a physical substrate, and with the color indicia 28 including a plurality of different colors selected from a predetermined palette lacking the color black.

Referring to FIG. 3, the example webpage 56 is displayed on the display 30 and operates as a GUI to receive the input information 18 as an input device 12. The example webpage includes a plurality 58 of input fields which activate pull-down menus and/or keyboard-input fields to select and/or input data. In the example embodiment, the webpage 56 generates a birth certificate, for example, at a government agency processing birth records from a hospital. Using “JAVASCRIPT” and “JAVA”-based software as the color indicia generating means 22, with “JAVA” being software commercially available from “SUN MICROSYSTEMS”, the browser displaying the HTML-based webpage 56 receives the input information 18.

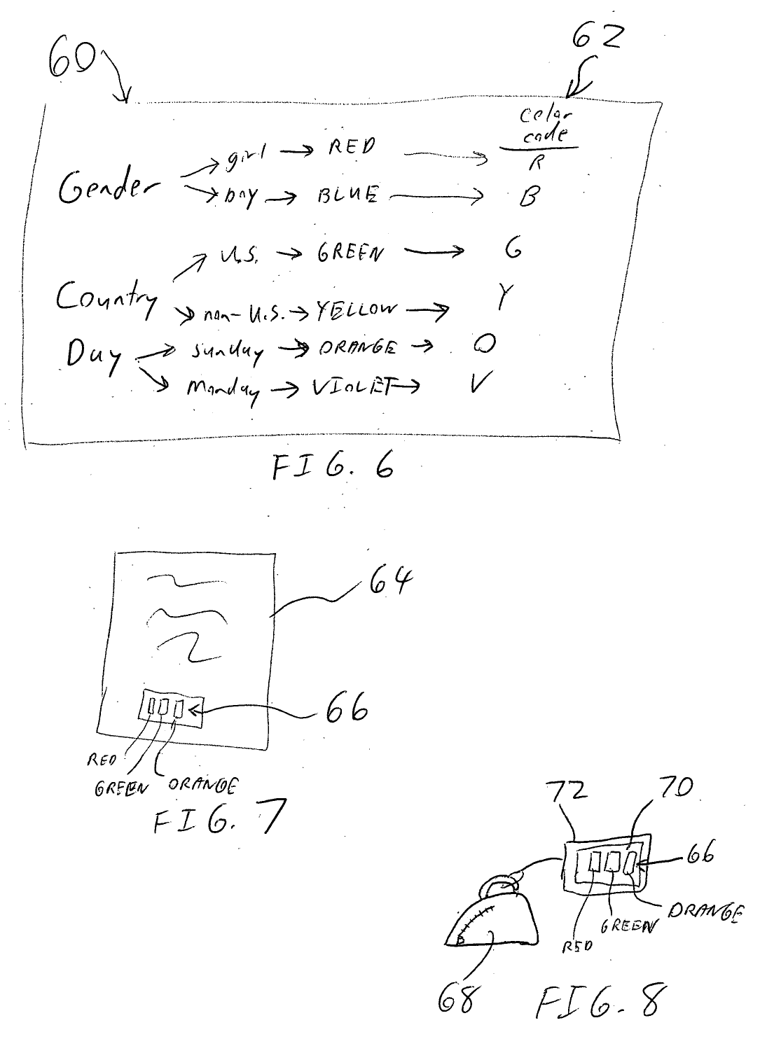

Using the predetermined mapping, for example, as shown in FIG. 6, in which gender is encoded either as RED or BLUE for girl or boy, respectively, in which the country is encoded as either GREEN or YELLOW for U.S. or non-U.S., respectively, and in which the day of birth is encoded as either ORANGE or VIOLET for Sunday or Monday, respectively, any child represented as the first object 20 is associated with a set of color codes 62 uniquely representing the child. It is understood that more complex and detailed mappings may be used, such as known hash functions to unique encode the name, city of birth, address, etc. of the child.

The system 10 and method 46 then may generate a birth certificate 64, for example, as shown in FIG. 7, having a unique identifying color indicia in the form of a color bar code 66 with at least two non-black colors, such as RED, GREEN, and ORANGE. The birth certificate 64 may be displayed on the colar display 30 as an on-screen substrate for review, and may then be printed by the color printer 34 on a paper substrate as an official color-bar-coded government document as the second object 36.

Alternatively, the person associated with the birth data as the input information 18 may have a travel bag 68 as the first object 20, for example, as shown in FIG. 8, with the color bar code 66 being printed by the color printer 34 on an adhesive sticker 70 as the physical substrate to be the second object 36 which is associated with the first object 20. That is, the adhesive sticker 70 is affixed to a removable tag 72 attached to the travel bag 68 of the person with the associated birth data.

Using the system 10 and method 46 described herein, the color indicia 28 may have a multitude of applications and may employ a nearly infinite palette of colors, such as cyan, magenta, aqua, silver, gold, scarlet, etc., with predetermined and pre-defined colors signifying specific days of the week, specific countries, specific cities, specific zodiac signs, etc.

Example uses of the multi-shaped and sized color bar codes include: identifying persons, foundations, materials, places, symbols, products, etc.; uses in security, education, electronic and non-electronic publication; entertainment; heliography and other signaling systems; security applications for airline passenger baggage; tracking of air-travel passengers and/or their belongings; personal identity; business identity for public an/or private sector activities; confidential information; personal data including medical records in general; medical records for patients at hospitals; banking identity verification systems for credit cards and other electronic cards; electronic signatures; government and private mail delivery services; courier mail delivery; parcels including identification of huge boxes and containers; sorting identification for multiple uses; map and road indications; personalized item identification; vehicle identification including land as well as air and sea vessels; valuable items of merchandise indicates by reference number and identity; identification of persons and corporations on the Internet; electronic matching of corporate color bar codes in parallel with predetermined corporate colors; publications such as posters, brochures, magazines, books, stickers, badges, shirts, and promotional materials; campaigns for elections, special interests, or sales promotions; color indicators for English words, Latin words, non-Latin words, and phonetic representations of words using the Latin alphabet; entertainment usage using color as a main elements such as a color scope for a person generated by blending the name of the person with their horoscope, or using the date and/or day to produce a variety of colors for each name; trademarks; identification of business corporations, universities, or other institutions; colors for fixed sets of data such as for the days of the week, for the months, for elements in an alphabet, for numerals, and for signs and symbols; stamps and coins and their quality, denomination, and source; major world locations such as countries, capitals, regions, cities, and villages; airports; historical persons including famous people; famous living persons; agendas represented by unique colors for the days of the week and months; daily colors for objects of fashion such as for clocks and watches for each day of the week; road signs indicating time and temperature for each day of the week; custom paint from paint manufacturers such as personalized colors for newly married couples blending their names, horoscopes, or relatives to create colors for rooms, walls, ceilings, doors, etc.; identification of credit cards beyond use in automatic teller machines (ATMs); vending machines and their functions; rental or purchase of software from corporations or uses on websites, vending machines, or states; media retention devices such a floppy disks, compact disks (CDs), digital versatile disks (DVDs), etc.; websites on the World Wide Web on the Internet; greeting cards incorporating the names or horoscopes of the purchasers or senders; personalized decorative or ornamental items such as necklaces, wristbands, wristlaces, ankle bracelets, fabrics, shirts, scarves, hats, towels, etc.; color codes for security shields on the Internet or networks including fire walls and access portals to prevent unauthorized violators from entering a website; satellite tracking to identify places or persons by color using a single special color or a combination of certain sets of colors by a fixed pattern, icons, seal, stamp, mark, tag, etc.; use in space technology and industry to coordinate interplanetary activities with different locations on the planets at fixed stations with each station having a unique pattern of colors which identify such locations and stations by allocation of each object through advanced technological software and hardware devices; and use in the cellular telephone industries to add new color-indexed features to its applications through specialized programming.

While the preferred embodiment of the present invention has been shown and described herein, it will be obvious that such embodiment is provided by way of example only. Numerous variations, changes and substitutions will occur to those skilled in the art without departing from the invention herein. Accordingly, it is intended that the invention be limited only by the spirit and scope of the appended claims.

What is claimed is:

1. A color coding system comprising:
an input device for inputting information associated with a first object;
a processor for processing the information using a predetermined mapping to generate a plurality of color codes uniquely identifying the first object; and
an output device for generating color indicia from the plurality of color codes, wherein the color indicia encodes the information associated with the first object, wherein the color indicia is viewable on a physical substrate, and wherein the color indicia including a plurality of different colors selected from a predetermined palette lacking the color black.

2. The color coding system of claim 1, wherein the predetermined palette includes colors selected from the group of: red, orange, yellow, green, blue, indigo, violet, and combinations thereof.

3. The color coding system of claim 1, wherein the input device is a webpage for receiving the information including a plurality of user-inputted menu selections; and
wherein the processor is a web server.

4. The color coding system of claim 3, wherein the output device is a multi-color display; and
wherein the physical substrate is a screen of the multi-color display.

5. The color coding system of claim 3, wherein the output device is a color printer.

6. The color coding system of claim 5, wherein the physical substrate is the first object.

7. The color coding system of claim 5, wherein the physical substrate is a second object attachable to the first object to be associated therewith.

8. The color coding system of claim 7, wherein the second object is an adhesive sticker to be disposed on the first object.

9. The color coding system of claim 1, wherein the color indicia are arranged in a series of parallel color lines representing a color bar code.

10. The color coding system of claim 1, wherein the color indicia are arranged in a rectangular array having at least two colored shapes in vertical direction, and at least two colored shapes in a horizontal direction.

11. A method for color coding a first object, the method comprising the steps of:
receiving information input into an input device, wherein the information is associated with a first object;
processing the information using a processor and a predetermined mapping;
generating a plurality of color codes uniquely identifying the first object;
generating color indicia from the plurality of color codes using an output device, wherein the color indicia encodes the information associated with the first object, wherein the color indicia is viewable on a physical substrate, and wherein the color indicia including a plurality of different colors selected from a predetermined palette lacking the color black.

12. The method of claim 11, wherein the predetermined palette includes colors selected from the group of: red, orange, yellow, green, blue, indigo, violet, and combinations thereof.

13. The method of claim 11, wherein the input device is a webpage for receiving the information including a plurality of user-inputted menu selections; and
wherein the processor is a web server.

14. The method of claim 13, wherein the output device is a multi-color display; and
wherein the physical substrate is a screen of the multi-color display.

15. The method of claim 13, wherein the output device is a color printer.

16. The method of claim 15, wherein the physical substrate is the first object.

17. The method of claim 15, wherein the physical substrate is a second object attachable to the first object to be associated therewith.

18. The method of claim 17, wherein the second object is an adhesive sticker to be disposed on the first object.

19. The method of claim 11, wherein the color indicia are arranged in a series of parallel color lines representing a color bar code.

20. The method of claim 11, wherein the color indicia are arranged in a rectangular array having at least two colored shapes in vertical direction, and at least two colored shapes in a horizontal direction.
